(19) United States
(12) Patent Application Publication
(10) Pub. No.: US 2016/0356641 A1
(43) Pub. Date: Dec. 8, 2016

(54) RELATIVISTIC WEIGHT MEASUREMENT AND NOTIFICATION SYSTEM FOR CONTAINERS

(71) Applicant: Semireg Industries, LLC, Winona, MN (US)

(72) Inventor: Caylan Van Larson, Winona, MN (US)

(73) Assignee: Semireg Industries, LLC, Winona, MN (US)

(21) Appl. No.: 15/171,834

(22) Filed: Jun. 2, 2016

Related U.S. Application Data
(60) Provisional application No. 62/169,628, filed on Jun. 2, 2015.

(51) Int. Cl. G01G 23/36; H04W 4/00

(52) U.S. Cl. CPC G01G 23/36; H04W 4/008; H04W 4/005

(57) ABSTRACT

A container weight notification system including a monitoring unit. The monitoring unit includes a housing maintaining a weighing device, a microcontroller, and an alert device. The weighing device signals information indicative of a current weight of a container associated with the housing to the microcontroller. The microcontroller is programmed to prompt the alert device to generate a notification based upon a comparison of the current weight information with a maximum weight value and a minimum weight value, for example as a calculated ratio. Notifications are optionally delivered (wired or wirelessly) by the microcontroller to a remote computing device operating a notification application. The monitoring unit can be separate from the product container or integrally formed with the container.

### CROSS REFERENCE TO RELATED APPLICATIONS

This Non-Provisional Patent Application claims the benefit of the filing date of U.S. Provisional Patent Application Ser. No. 62/169,628, filed Jun. 2, 2016, entitled “RELATIVISTIC WEIGHT MEASUREMENT AND NOTIFICATION SYSTEM FOR CONTAINERS,” the entire teachings of which is herein incorporated by reference.

### BACKGROUND

The present disclosure relates to monitoring the fill status of a container. More particularly, it relates to automated systems and methods for notifying a user as the quantity or volume or weight of the container, including the container's contents, is depleted.

Every day, people and businesses consume goods stored in containers. Under many circumstances, the consumer will manually evaluate the quantity or volume of product remaining in a particular container by one or more of visual inspection, touch and feel, or shake and listen. An accurate or precise measurement of the actual quantity or volume of the product in the container is not necessary; the user only desires a gross estimate of whether a sufficient amount of product remains in the container. However, if physical inspection is inconvenient or easily forgotten, the consequences can be uncomfortable or inefficient.

In other scenarios, a precise determination of the remaining quantity or volume is necessary, for example with manufacturing equipment and large scale product supply chain monitoring. Complex measuring systems have been developed to meet these needs, and oftentimes entail multiple sensors, weight scales, balances, and software. Balances, which differ from scales in that they measure mass, sometimes include features such as counting and functions for check-weighing. While highly useful for their intended end use application and capable of generating an exact value (e.g., mass, weight, quantity, volume, liquid level, etc.), these complex systems are not viable for most product container evaluation situations in terms of at least cost and size.

In light of the above, a need exists for inexpensive systems and corresponding methods for generating a gross estimation of product remaining in a container and notifying a user of the same.

### SUMMARY

Some aspects of the present disclosure are directed toward a container quantity notification system including a monitoring unit. The monitoring unit includes a housing maintaining a weighing device, a microcontroller, and an alert device. The weighing device signals information indicative of a current weight of a container associated with the housing to the microcontroller. The microcontroller is programmed to prompt the alert device to generate a notification based upon a comparison of the current weight information with a maximum weight value and a minimum weight value, for example as a calculated ratio. Notifications are optionally delivered (wired or wirelessly) by the microcontroller to a remote computing device operating a notification application. The monitoring unit can be separate from the container or integrally formed with the container.

The monitoring units of the present disclosure can leverage a sensed parameter indicative of container weight to calculate relative weight information, and notify the user. The monitoring unit digitally measures and compares the current weight against pre-configured or user-defined full (maximum) and refill (minimum) weight values. With that information, the unit calculates a ratio, and delivers the ratio to the user as a notification via audio speaker, visual indicator such as flashing LED lights, wirelessly to a connected mobile or other remote computing device.

### BRIEF DESCRIPTION OF THE DRAWINGS

FIG. 1 is a block diagram of a container weight notification system in accordance with principles of the present disclosure;

FIG. 2 is a simplified perspective view of a container being located on a portion of the system of FIG. 1;

FIG. 3 is a simplified cross-sectional view of another container weight notification system in accordance with principles of the present disclosure;

FIG. 4 is a simplified side view of another container weight notification system in accordance with principles of the present disclosure; and

FIG. 5 is a block diagram of another container weight notification system in accordance with principles of the present disclosure

### DETAILED DESCRIPTION

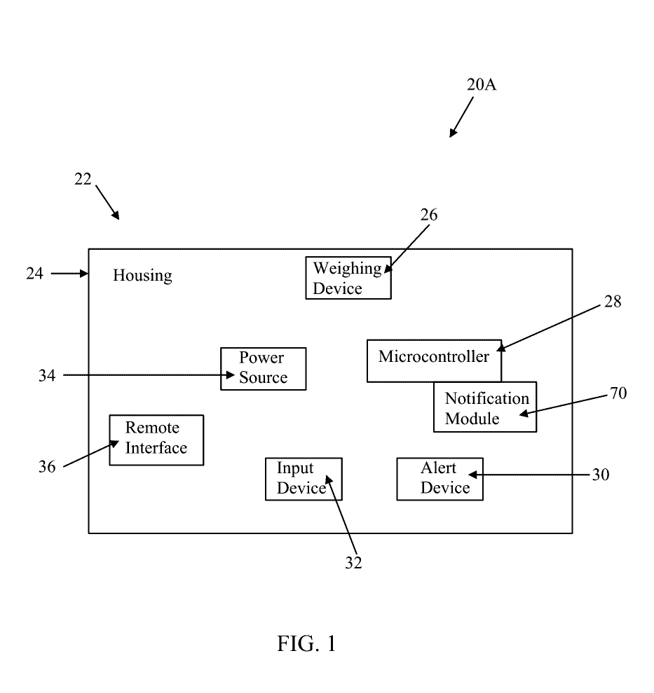

One embodiment of a container weight notification system 20A in accordance with principles of the present disclosure is shown in block form in FIG. 1. The system 20A includes a monitoring unit 22 that comprises at least a housing 24, a weighing device 26, a microcontroller 28, and an alert device 30. The monitoring unit 22 can further optionally include one or more of a user input device 32, a power source 34, and a remote interface device 36. Details on the various components are provided below. In general terms, the weighing device 26 and the alert device 30 are carried by the housing 24 and electronically communicate with the microcontroller 28. Where provided, the user input device 32, the power source 34 and/or the remote device 36 can also be carried by the housing 24 and electronically connected to the microcontroller 28. The weighing device 26 generates current weight information indicative of a weight of a container (not shown) located on the housing 24, and signals the current weight information to the microcontroller 28. The microcontroller 28 is programmed to prompt the alert device 30 to generate a notification based upon a comparison of the current weight information with a maximum weight value and a minimum weight value. The maximum and minimum weight values, in turn, represent differing fill levels of a product within the container (e.g., the maximum weight value is indicative of the container being full, and the minimum weight value is indicative of the container being empty, nearly empty, requiring refilling, or otherwise requiring user attention). The so-generated notification can assume various forms, and is a relativistic representation or ratio of the current weight (and thus current fill level) of the container with respect to the maximum weight (and thus full fill level) of the container and the minimum weight (and thus empty or nearly empty fill level). A user is thus provided with a gross estimate of the container's fill level from which a decision to take action can be made.

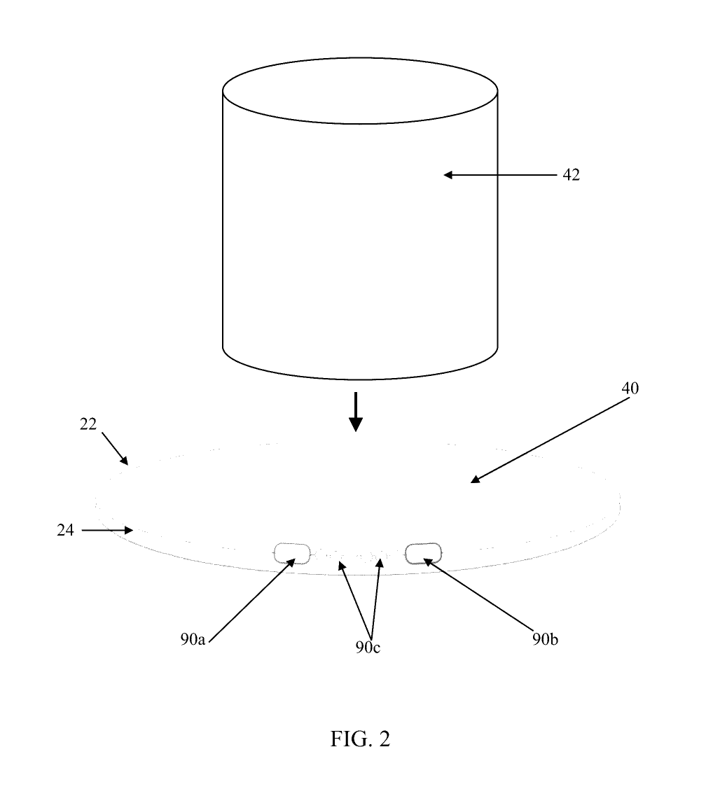

In some embodiments, the monitoring unit 22 is provided apart from the container to be monitored, with the housing 24 providing or maintaining a platform 40 on to which a container 42 can be selectively placed as generally represented by the non-limiting example of FIG. 2. The platform 40 can have a variety of shapes and sizes, and is linked or connected to the weighing device 26 (FIG. 1). In related embodiments, the platform 40 can be considered a component of the weighing device 26. Regardless, the housing 24 can be formed from a variety of materials (plastic, metal, etc.) that are optionally flexible, non-corrosive, resistant to acids, and non-staining. In some embodiments, the housing 24 provides a water resistant enclosure for the contained components. In other embodiments, at least a portion of the housing 24 (e.g., the platform 40) can include a removable, durable, and rubberized shield that is optionally available to the user in different colors.

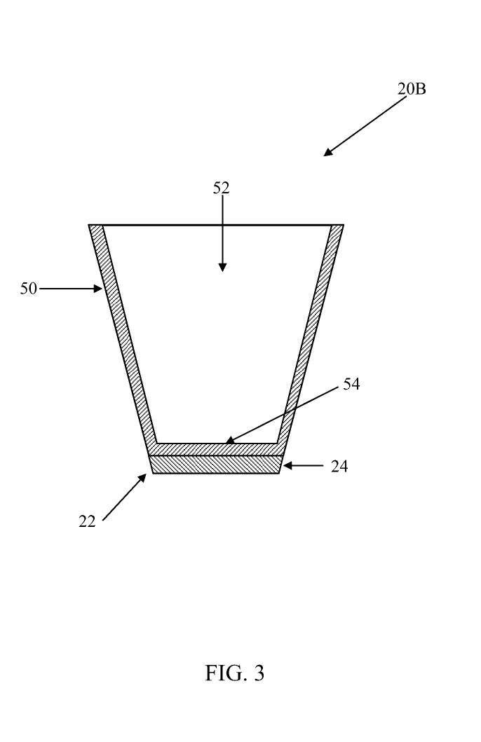

In other embodiments, the monitoring unit 22 can be provided as an integral part of the product container. For example, FIG. 3 is a simplified representation of an alternative weight notification system 20B in which the monitoring unit 22, and in particular the housing 24, is provided as an integral component of a container 50. The container 50 generally defines one or more chambers 52 within which product (not shown) can be received, with the chamber 52 terminating at a bottom wall 54. The housing 24 (and the monitoring unit components carried thereby) can be assembled at or near the bottom wall 54 such that weight information generated by the weighing device 26 (FIG. 1) is indicative of a weight of the contained product. Alternatively, the weighing device 26 could be permanently installed to the bottom interior of the chamber 52 (or embedded inside the material of the bottom wall 54), that way bypassing the weight of the container 50 entirely.

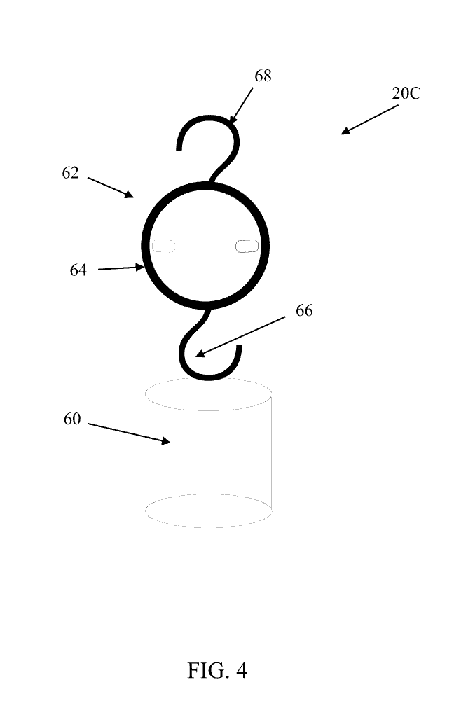

In other embodiments, the systems of the present disclosure can be configured to support the container in question in hanging-type fashion (as contrasted to previous embodiments in which the container was placed on top of a platform). For example, FIG. 4 is a simplified illustration of another weight notification system 20C in accordance with principles of the present disclosure and associated with a container 60. The system 20C includes a monitoring unit 62 that is highly akin to any of the monitoring units described elsewhere in the present disclosure. With the construction of FIG. 20C, the monitoring unit 62 includes a housing 64 configured to promote a hanging-type connection to, or support of, the container 60. For example, the housing 64 can include a support assembly 66 configured for connection to a corresponding component of the container 60 in a hanging manner (e.g., the support assembly 66 can be or include a hook). The support assembly 66 is connected to the weighing device (not shown, but akin to the weighing device 26 of FIG. 1) of the monitoring unit 62 such that a force or strain at the support assembly 66 (i.e., a weight of the container 60) is sensed by the weighing device. In other embodiments, the support assembly 66 can be considered to be a component of the weighing device. The system 20C optionally further includes an anchor structure 68 connected to, or as part of, the housing 64 and adapted for mounting the system 20C to an environmental structure. The system 20C operates in accordance with the descriptions provided elsewhere in the present disclosure in providing a relativistic evaluation of a current fill status of the container 60 based on a sensed parameter indicative of weight. Thus, the support assembly 66 is akin to or the equivalent of the platform 40 (FIG. 2) described above.

Returning to FIG. 1, the weighing device 26 can assume a variety of forms known in the art or in the future developed, and appropriate for measuring weight or mass. The weighing device 26 can be or include one or more sensors that measure a parameter indicative of weight, for example a strain gauge sensor design such as foil gauge, piezo resistors, nanoparticle-based, MEMS, capacitive, etc. The weighing device 26 can be configured to generate information or data that is linear with respect to weight and also is temperature compensated. Other weighing device constructions are also acceptable, such as a modular system where discrete weighing devices can be connected to achieve an aggregate strain measurement. These weighing devices can be made electrically interchangeable to accommodate different sized containers. This is possible with the systems of the present disclosure because the measurements received from the weighing device do not need to be calibrated to any particular unit (e.g., kilogram or imperial pound). The raw measurements are used only for the relativistic calculations and analyses described below.

The microcontroller 28 can assume various forms known in the art, including various circuitry and circuit chip(s) that can be programmed to perform computer-like operations and optionally includes or operates a memory. The microcontroller 28 is programmed to receive current weight information from the weighing device 26, and to compare the current weight information against a pre-determined or user-defined maximum (or full) weight value and a minimum (or refill or empty) weight value. From this comparison, the microcontroller 28 is programmed to calculate a ratio and effectuate or prompt “delivery” of this ratio to the user via the alert device 30 and/or other devices as described below.

The programming, algorithms, instructions, codes, script and/or data appropriate for performing the comparison and ratio calculations, as well as for formatting a desired output by the alert device 30, can be included with a notification module 70 stored by the microcontroller 28. Programming for other optional operations described below can also be included with the notification module. The programming can be written in a format appropriate for execution by the microcontroller 28, such as known text-based programming languages, graphical programs, assembly languages, etc. The operations implemented by the programming for generating a particular notification can include the step of first determining the range or difference (“Range”) between the maximum weight value (“Max”) and the minimum weight value (“Min”) as:

Range=Max−Min.

The difference (“Diff”) between the current weight (“Current”) and the minimum weight value is also determined as:

Diff=Current−Min.

Finally, a ratio (“R”) of the difference (Diff) versus the range (Range) is determined. For example, the ratio R can be designated as:

R=Diff/Range.

The ratio R can be expressed in various manners. For example, the ratio R can be a percentage where Diff/Range is multiplied by 100.

By way of one non-limiting example, for a certain container usage application, the maximum weight value is 20 and the minimum weight value is 10 (it being recalled that the unit of measurement is not necessary with the systems of the present disclosure). Under circumstances where a current weight of the container (otherwise containing a product) is found or measured to be 18, the analyses performed by the systems of the present disclosure can include calculating the range to be 10 (i.e., 20−10), the difference to be 8 (i.e., 18−10), and the ratio to be 0.8 (i.e., 8/10). In other words, in relativistic terms, it is determined that the container fill level is currently at 80%. A number of other similar methodologies can be employed to arrive at a relativistic evaluation of the current fill level based on the sensed parameter otherwise indicative of current weight.

The maximum and minimum weight values can be provided to (and stored by) the microcontroller 28 in various manners. In some embodiments (e.g., embodiments where the monitoring unit 22 is provided as an integral component of the container, and the container is used to contain a known product quantity or volume (and thus known product weight)), the maximum and minimum weight values can be pre-programmed to a memory of the microcontroller 28. In other embodiments (e.g., those in which the product container is separate from the monitoring unit 22), the systems of the present disclosure are configured such that a user can “enter” or designate the maximum and minimum weight values, with the so-entered values then being specific to a particular container, a particular good or product held by the container, and the intended or desired use of the product container.

For example, the minimum weight value can be a weight of a particular container when empty; the maximum weight value can be a weight of that same container when filled with a desired product to a level deemed by the user as “full”. The minimum weight value can thus be recorded at or by the microcontroller 28 for example by a user first placing the empty container on to the platform 40 (or other surface of the housing 24 at which the container is intended to be stored); in response, the weighing device 26 generates the current weight information that is otherwise indicative of the weight of the empty container. The user then prompts the microcontroller 28 to store or record this weight information as the minimum weight value. The user then fills the container to a desired level with the product(s) of interest; in response, the weighing device 26 generates the current weight information that is otherwise indicative of the weight of the now-full container. The user prompts the microcontroller 28 to store or record this weight information as the maximum weight value. In this regard, the system 20A can include the optional user input device 32 with the housing 24 in a format conducive for user-prompted assignment of the minimum and maximum weight values. For example, the user input device 32 can be or include a touch pad(s) or similar device with indicia or information that instructs the user as to how minimum and maximum weight values can be entered (e.g., a first touch pad with indicia “empty” or similar icons and/or pictures, and a second touch pad with indicia “full” or similar icons and/or pictures). Other user input device 32 formats (carried by the housing 24) are also acceptable.

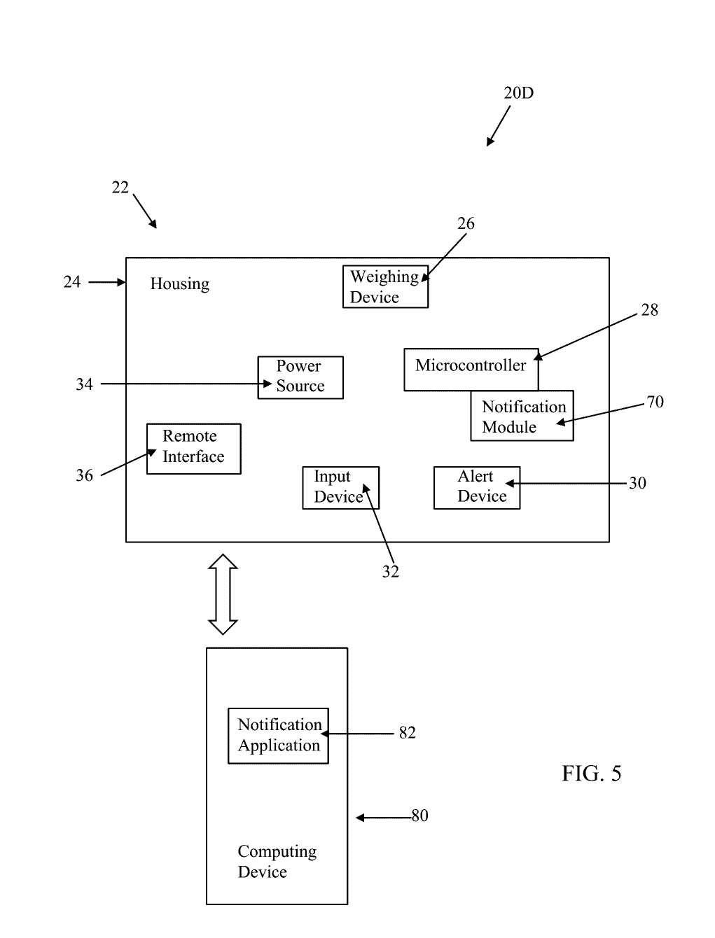

In other embodiments, the microcontroller 28 can be remotely prompted to store the maximum and minimum weight values. For example, the alternative system 20D of FIG. 5 includes a computing device 80 apart from the monitoring unit 22. The computing device 80 can assume a variety of forms, such as a handheld or mobile device (smart phone, PDA, wearable computer, tablet, laptop computer, etc.), desktop computer, etc. Regardless, the computing device 80 is programmed or loaded with a notification application 82 (e.g., a software program that may be stored in a memory and is executable by a processor, a hardware configuration program useable for configuring a programmable hardware element, etc.) providing necessary instructions or code for interfacing with the microcontroller 28 in a desired fashion via the remote interface device 36. In some embodiments, the microcontroller 28 and the computing device 80 interface or communicate wirelessly, for example where the remote interface device 36 connected to (or provided with) the microcontroller 28 is or includes a wireless transceiver (or similar circuitry components). In other embodiments, a wired interface between monitoring unit 22 and the computing device 80 can be provided. Regardless, the notification application 82 can facilitate user-directed designation and storage of the maximum and minimum weight values, such as via the user indicating at the computing device 80 that an empty container is associated with the monitoring unit 22 (i.e., the minimum weight value as described above) followed by an indication that the now-full container is on the platform (i.e., the maximum weight value as described above). A number of other maximum and minimum weight designation operations can be implemented by the computing device 80 and forwarded (wired or wirelessly) to the microcontroller 28, such as the user entering numerical values as the maximum and minimum weight values. The notification application 82 can alternatively be programmed to perform other operations as described below.

Returning to FIG. 1, in addition to performing the relativistic weight determinations described above, the microcontroller 28 is programmed to prompt operation of the alert device 30 in accordance with the determined or estimated ratio. As described below, the alert device 30 can assume a variety of different forms, with the microcontroller 28 (e.g., the notification module 70) adapted to interface with the particular format of the alert device 30. Depending upon the capabilities of the alert device 30, the microcontroller 28 can be programmed to generate different notifications at the alert device 30. For example, the alert device 30 can be prompted to provide a continuous or constant indication of the gross determination of the quantity or volume or weight of product currently in the container, a continuous or constant indication of current quantity or volume or weight relative to the designated maximum and minimum values, a warning or alert when the estimated current quantity or volume or weight is at or is approaching the minimum value, etc.

The microcontroller 28 can optionally be programmed (e.g., via the notification module 70) to perform one or more additional operations. For example, the microcontroller 28 optionally prompts periodic operation of the weighing device 26 (vs. continuous operation) so as to reduce power consumption. The measurement or operation intervals can be pre-determined, or can be selected by a user. Other optional operational features include affording the user the ability to set multiple notification thresholds such as “less than 10%” or “greater than 80%”), using rate of change to provide forecasting of notification events, obtaining usage patterns such as “Monday is our busiest day”, or adding ignore or sleep time periods so operation is limited to particular times of day such as business hours.

The alert device 30 can assume various forms known in the art, and in some embodiments includes one or both of a visual indicator and an audio indicator. The visual indicator can include one or more light sources, such as LEDs. For example, the non-limiting embodiment of FIG. 2 shows the alert device 30 as including a plurality of LEDs 90 arranged in a continuous row. The LEDs 90 can assume any form known in the art, and in some embodiments can be colored. The LEDs 90 include a minimum level LED 90a (e.g., red), a maximum level LED 90b (e.g., blue), and a series of incremental level LEDs 90c (e.g., green). As the estimated quantity or volume or weight of product in the container 50 decreases over time, a lesser number of the incremental LEDs 90c will be illuminated (prompted by the microcontroller 28 as described above), providing a user with a visual indication or notification of the fill status of the container 50. As the calculated ratio approaches zero, one or more of the LEDs 90 can be prompted to flash. Other visual notification formats are equally acceptable that may or may not include selectively illuminated LEDs. For example, the alert device 30 can include a display screen such as a low-power E-ink display. With embodiments in which the alert device 30 includes a display screen or similar device, the microcontroller 28 (e.g., via the notification module 70) can be programmed to prompt display of other information at the display screen. For example, the difference (Diff) and/or the range (Range) determinations as described above can be displayed to a user (either automatically or in response to a user prompt). Range, for example, can be useful for knowing how much accuracy is available for a particular min/max configuration. Diff can be important for similar reasons. The optional audio indicator can include an audio speaker.

In addition, or as an alternative, to prompted operation of the alert device 30 (otherwise carried by the housing 24), the microcontroller 28 can be programmed to generate alert information at a remote device. For example, and with reference to FIG. 5, the computing device 80 can be provided, loaded with the notification application 82. With some embodiments, the notification application 82 is programmed to issue notification(s) at the computing device 80 as prompted by the microcontroller 28 (via the remote interface device 36). The so-provided notifications can assume various forms, including an alert that the estimated current quantity or volume or weight of product in the container is at or approaching the minimum value, maximum value, or any other configurable or selected threshold. Other information, such as the range (Range) and/or difference (Diff) as described above can also be provided to a user at the computing device 80.

As mentioned above, systems of the present disclosure optionally include wired or wireless interface with the notification application 82 stored on the remote computing device 80. With optional embodiments employing wireless communication, the wireless connection established by the remote interface device 36 can take various forms known in the art. For example, the wireless connection can leverage Bluetooth Low Energy (i.e., Bluetooth 4.0, BLE), iBeacon, an internet service, built-in cellular or wi-fi radio, etc.

As a point of reference, the optional BLE wireless connectivity is available on the majority of modern mobile devices. BLE is commonly used for heart rate sensors, temperature probe sensors, and other sensor applications where the user is in close-to-medium proximity of the sensor. BLE sensors operate in one of two modes: advertising mode and connected mode. When advertising, the sensor sends a limited amount of one-way identification data to all listening devices. When connected, the sensor can be both read from (sensing), and written to (control). Most sensors can only be connected to one mobile device at a time. If a sensor is already connected to a mobile device, the sensor will be invisible to other mobile devices.

In order to preserve battery life of mobile devices, mobile device operating systems, such as Apple, Inc.'s (Apple) iOS, strictly limits how long an app can run when the app is not the foremost app (background operation via home button or power button). Normally, an app is suspended or terminated when it runs in the background. When an app is connected to a BLE sensor, the app is allowed to run to service the sensor connection. However, when an app is solely listening for advertising sensors (not connected to at least one BLE sensor), the app will still be suspended or terminated. This difference in app behavior when near advertising sensors is a problem Apple has solved with iBeacon.

iBeacon is an Apple-branded methodology based on BLE advertising mode. iBeacon allows apps to be automatically run when a nearby BLE sensor is advertising. This automation happens when a particularly configured app is installed on the mobile device and that mobile device's screen is turned on.

Apple offers another methodology for smart devices known as HomeKit. It is possible to integrate the systems of the present disclosure as a HomeKit Accessory, allowing for easy and secure configuration of the device. Building for HomeKit will allow future integrations with Apple's device ecosystem including Apple Watch and Siri for voice assistance.

Returning to FIG. 1, the monitoring units of the present disclosure optionally include the on-board power source 34 carried by the housing 22. The power source 34 can be one or more batteries as known in the art. Alternatively, necessary power for operation of the weighing device 26, the microcontroller 28 and/or other components can be a conventional wall source power supply.

The weight notification systems of the present disclosure are useful in a wide range of environments, monitoring the fill status of multiple different containers/products. The systems can be used in residential environments. For example, the systems can be employed as houseplant watering guides (in which the “product” to be monitored is moisture contents of the soil in which the houseplant is potted). The houseplant is placed onto the platform 40 (FIG. 2) or hung from the support assembly 66 (FIG. 4). Dry soil weighs less than wet soil. The notification information could inform a user as to when the houseplant needs watering and/or guide the user in “topping off” the water with the correct amount. The systems can be employed to provide bulk product alerts. Flour and sugar (and other product) containers weigh less when a user needs to buy more. The systems can be employed with pet food bowls. A pet's food or water bowl weighs less when the animal may be at risk for thirst or have an empty stomach. The systems can be employed to provide trash-related alerts. Notifications or reminders of “take out the trash” or “bring the trash can in from the berm” with passive monitoring of heavy objects such as trash cans or recycle bins. The systems can be employed to assist persons with disabilities. Relieving everyday inconveniences can increase quality of life.

Alternatively, the systems of the present disclosure can be useful in industrial and commercial environments. For example, the systems can be employed to monitor the fill status of bulk liquids. Beer kegs, for example, are opaque and can be heavy and stored in places difficult to reach. Beer kegs weigh less when becoming close to empty. The systems can be employed to provide bulk good product alerts. Grocery stores lose money when bulk dispensing containers are empty. Each bulk container can be integrated with a built-in system of the present disclosure. A mobile app can notify employees of containers that need attention. Data can be integrated into inventory management systems. The systems can be employed to monitor supplies. Supply bins weigh less when supplies need to be reordered. The systems can be employed to monitor curing or fermentation processes where moisture evaporates; such as hanging sausages, cheeses, etc. (e.g., via the support assembly 66 of FIG. 4). The systems can be employed to monitor consumer products. Consumables can be automatically reordered. Consumer product containers can be integrated with an inexpensive, built-in system of the present disclosure that is configured or programmed with default minimums. A mobile app can generate a list of items that are low. This list may be automatically sent to an online retailer for fulfillment.

The weight notification systems and methods of the present disclosure provide a marked improvement over previous designs. The systems are effectively an inexpensive, long-lasting, battery-operated (optionally) digital balance that uses a sensed parameter otherwise indicative of current weight to calculate relative quantity or volume information, and provides gross notifications to a user. The system digitally measures and compares the current weight against pre-configured or user-defined full (maximum) and refill (minimum) weight values. With that information, the system calculates a ratio, and delivers the ratio to the user as a notification via audio speaker, visual indicator such as flashing LED, wirelessly to a connected mobile device or wearable device leveraging Bluetooth Low Energy, iBeacon, or using built-in Wi-Fi and/or cellular radio and the like that communicates directly with an internet-based service (e.g., prompting users on their mobile or desk-top devices). The systems of the present disclosure can be built-in to existing containers or sold separately as a standalone device. Either way, the systems can be used with or without a mobile device. The weight notification systems of the present disclosure optionally provide for periodic measuring and configurable interval for reduced battery usage. The systems optionally provide for user selected or configurable notification thresholds and hysteresis. Optional physical buttons provided with the system include power on and off, set minimum, set maximum, alarm selector, button lock, wireless connectivity, etc. Remote configuration via a mobile app is optionally provided.

Although the present disclosure has been described with reference to preferred embodiments, workers skilled in the art will recognize that changes can be made in form and detail without departing from the spirit and scope of the present disclosure.

What is claimed is:

1. A container weight notification system comprising a notification unit, the notification unit including:
a housing;
a weighing device carried by the housing and adapted to generate current weight information indicative of a current weight of a container associated with the housing;
an alert device carried by the housing; and
a microcontroller carried by the housing and electronically connected to the weighing device and the alert device;
wherein the microcontroller is programmed to prompt the alert device to generate a notification based upon a comparison of the current weight information with a maximum weight value and a minimum weight value.

2. The system of claim 1, wherein the microcontroller is further programmed to determine a ratio of the current weight information relative to the maximum weight value and the minimum weight value.

3. The system of claim 1, wherein the microcontroller is further programmed to receive and store the maximum weight value and the minimum weight value.

4. The system of claim 3, wherein the monitoring unit further comprises a user input device carried by the housing and configured to receive user-entered information indicative of the maximum weight value and the minimum weight value.

5. The system of claim 3, further comprising a notification application remote of the notification unit and in communication with the microcontroller, the notification application programmed to receive user-entered information indicative of the maximum weight value and the minimum weight value, and to deliver the received information to the microcontroller.

6. The system of claim 1, wherein the housing includes a platform configured to selectively receive a container.

7. The system of claim 1, wherein the housing includes a support assembly for maintaining a container in a hanging fashion.

8. The system of claim 1, wherein the housing is integrally formed with the container.

9. The system of claim 1, wherein the weighing device includes a sensor selected from the group consisting of a foil gauge, a piezo resistor strain gauge, a nanoparticle-based strain gauge, an MEMS strain gauge, and a capacitive strain gauge.

10. The system of claim 1, wherein the weighing device includes a plurality of weighing devices configured to be connected to provide an aggregated strain measurement.

11. The system of claim 1, wherein the alert device includes at least one of lights, colored lights, and an audio speaker.

12. The system of claim 1, wherein the alert device is configured to generate a gross visual indication of a relationship of the current weight information relative to the maximum weight value and the minimum weight value.

13. The system of claim 1, further comprising a notification application remote from the monitoring unit and in communication with the microcontroller, the notification application programmed to generate a remote notification to a user based upon the comparison of the current weight information with a maximum weight value and a minimum weight value.

14. The system of claim 13, wherein the microcontroller is programmed to prompt operation of the notification application in generating the remote notification.

15. The system of claim 1, wherein the monitoring unit further comprises a power source carried by the housing.

16. The system of claim 1, wherein the microcontroller is programmed to prompt operation of the weighing device to obtain the current weight information on a periodic basis.
